(19) United States
(12) Patent Application Publication
(10) Pub. No.: US 2018/0285908 A1
(43) Pub. Date: Oct. 4, 2018

(54) EVALUATING POTENTIAL SPENDING FOR CUSTOMERS OF EDUCATIONAL TECHNOLOGY PRODUCTS

(71) Applicant: LinkedIn Corporation, Sunnyvale, CA (US)

(72) Inventors: Zhaoying Han, Mountain View, CA (US); Yiying Cheng, Mountain View, CA (US); Juan Wang, Los Altos, CA (US); Wenjing Zhang, Menlo Park, CA (US)

(73) Assignee: LinkedIn Corporation, Sunnyvale, CA (US)

(21) Appl. No.: 15/478,023

(22) Filed: Apr. 3, 2017

(51) Int. Cl. G06Q 30/02; G06Q 50/20; G06Q 10/06

(52) U.S. Cl. CPC G06Q 30/0206; G06Q 10/067; G06Q 50/20

(57) ABSTRACT

The disclosed embodiments provide a system that processes data. During operation, the system obtains a set of features for a customer of an educational technology product. Next, the system uses an account type of the customer to select a statistical model from a set of statistical models for evaluating potential customer spending with the educational technology product. The system then uses the statistical model and the features to predict a potential spending of the customer with the educational technology product. Finally, the system outputs the potential spending for use in managing sales activity with the customer.

### RELATED APPLICATION

The subject matter of this application is related to the subject matter in a co-pending non-provisional application by inventors Zhaoying Han, Coleman Patrick King III, Yiying Cheng and Juan Wang, entitled “Evaluating and Comparing Predicted Customer Purchase Behavior for Educational Technology Products,” having Ser. No. 15/195,870, and filing date 28 Jun. 2016 (Attorney Docket No. LI-P2017.LNK.US).

### BACKGROUND

### Field

The disclosed embodiments relate to techniques for managing sales activities. More specifically, the disclosed embodiments relate to techniques for evaluating potential spending for customers of educational technology products.

### Related Art

Social networks may include nodes representing entities such as individuals and/or organizations, along with links between pairs of nodes that represent different types and/or levels of social familiarity between the entities represented by the nodes. For example, two nodes in a social network may be connected as friends, acquaintances, family members, and/or professional contacts. Social networks may further be tracked and/or maintained on web-based social networking services, such as online professional networks that allow the entities to establish and maintain professional connections, list work and community experience, endorse and/or recommend one another, run advertising and marketing campaigns, promote products and/or services, and/or search and apply for jobs.

In turn, social networks and/or online professional networks may facilitate sales and marketing activities and operations by the entities within the networks. For example, sales professionals may use an online professional network to identify prospective customers, maintain professional images, establish and maintain relationships, and/or close sales deals. Moreover, the sales professionals may produce higher customer retention, revenue, and/or sales growth by leveraging social networking features during sales activities. For example, a sales representative may improve customer retention by tailoring his/her interaction with a customer to the customer's behavior, priorities, needs, and/or market segment, as identified based on the customer's activity and profile on an online professional network.

Consequently, the performance of sales professionals may be improved by using social network data to develop and implement sales strategies.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a flowchart illustrating a process of using a statistical model to predict the potential spending of a customer with an educational technology product in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

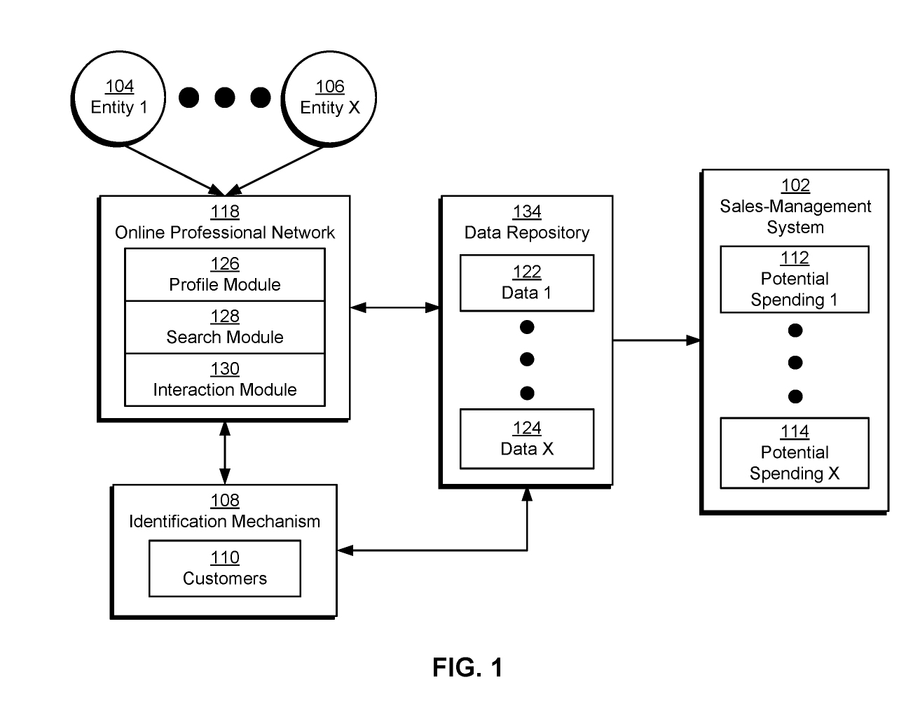

The disclosed embodiments provide a method, apparatus, and system for processing data. More specifically, the disclosed embodiments provide a method, apparatus, and system for evaluating potential spending for customers of educational technology products. As shown in FIG. 1, customers 110 may be members of a social network, such as an online professional network 118 that allows a set of entities (e.g., entity 1 104, entity x 106) to interact with one another in a professional and/or business context.

The entities may include users that use online professional network 118 to establish and maintain professional connections, list work and community experience, endorse and/or recommend one another, and/or search and apply for jobs. The entities may also include companies, employers, and/or recruiters that use the online professional network to list jobs, search for potential candidates, and/or provide business-related updates to users.

The entities may use a profile module 126 in online professional network 118 to create and edit profiles containing profile pictures, along with information related to the entities' professional and/or industry backgrounds, experiences, summaries, projects, and/or skills. The profile module may also allow the entities to view the profiles of other entities in the online professional network.

Next, the entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature on the online professional network to search for profiles, jobs, and/or information by categories such as first name, last name, title, company, school, location, interests, relationship, industry, groups, salary, and/or experience level.

The entities may also use an interaction module 130 to interact with other entities on online professional network 118. For example, the interaction module may allow an entity to add other entities as connections, follow other entities, send and receive messages with other entities, join groups, and/or interact with (e.g., create, share, re-share, like, and/or comment on) posts from other entities.

Those skilled in the art will appreciate that online professional network 118 may include other components and/or modules. For example, the online professional network may include a homepage, landing page, and/or newsfeed that provides the entities with the latest postings, articles, and/or updates from the entities' connections and/or groups. Similarly, the online professional network may include mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, and/or other action performed by an entity in the online professional network may be tracked and stored in a database, data warehouse, cloud storage, and/or other data-storage mechanism providing data repository 134.

The entities may also include a set of customers 110 that purchase products through online professional network 118. For example, the customers may include individuals and/or organizations with profiles on the online professional network and/or sales accounts with sales professionals that operate through the online professional network. As a result, the customers may use the online professional network to interact with professional connections, list and apply for jobs, establish professional brands, purchase or use products offered through the online professional network, and/or conduct other activities in a professional and/or business context.

Customers 110 may also be targeted for marketing or sales activities by other entities in online professional network 118. For example, the customers may be companies that purchase business products and/or solutions that are offered by the online professional network to achieve goals related to hiring, marketing, advertising, and/or selling. In another example, the customers may be individuals and/or companies that are targeted by marketing and/or sales professionals through the online professional network.

As shown in FIG. 1, customers 110 may be identified by an identification mechanism 108 using data from data repository 134 and/or online professional network 118. For example, identification mechanism 108 may identify the customers by matching profile data, group memberships, industries, skills, customer relationship data, and/or other data for the customers to keywords related to products that may be of interest to the customers. Identification mechanism 108 may also identify the customers as individuals and/or companies that have sales accounts with the online professional network and/or products offered by or through the online professional network. As a result, the customers may include entities that have purchased products through and/or within the online professional network, as well as entities that have not yet purchased but may be interested in products offered through and/or within the online professional network.

Identification mechanism 108 may also match customers 110 to products using different sets of criteria. For example, the identification mechanism may match customers in recruiting roles to recruiting solutions, customers in sales roles to sales solutions, customers in marketing roles to marketing solutions, customers in learning and development roles to educational technology products, and customers in advertising roles to advertising solutions. If different variations of a solution are available, the identification mechanism may also identify the variation that may be most relevant to the customer based on the size, location, industry, and/or other attributes of the customer. In another example, products offered by other entities through online professional network 118 may be matched to current and/or prospective customers through criteria specified by the other entities. In a third example, the customers may include all entities in the online professional network, which may be targeted with products such as “premium” subscriptions or memberships with the online professional network.

After customers 110 are identified, they may be targeted by one or more sales professionals with relevant products. For example, the sales professionals may engage the customers with recruiting, marketing, sales, and/or advertising solutions that may be of interest to the customers. After a sales deal is closed with a given customer, a sales professional may follow up with the customer to improve the customer lifetime value (CLV) and retention of the customer.

To facilitate prioritization of sales activities with the customers, a sales-management system 102 may determine a potential spending (e.g., potential spending 1 112, potential spending x 114) of each customer. The potential spending may represent the maximum future spending of the customer with an educational technology product (e.g., e-learning product) offered by or within online professional network 118. As described in further detail below, the sales-management system may use an account type of the customer to select a statistical model from a set of statistical models for evaluating potential customer spending with the educational technology product. The sales-management system may then use the statistical model to predict a potential spending of the customer with the educational technology product. In turn, the predicted potential spending may facilitate sales and/or business operations such as territory planning, marketing, and/or total addressable market (TAM) analysis.

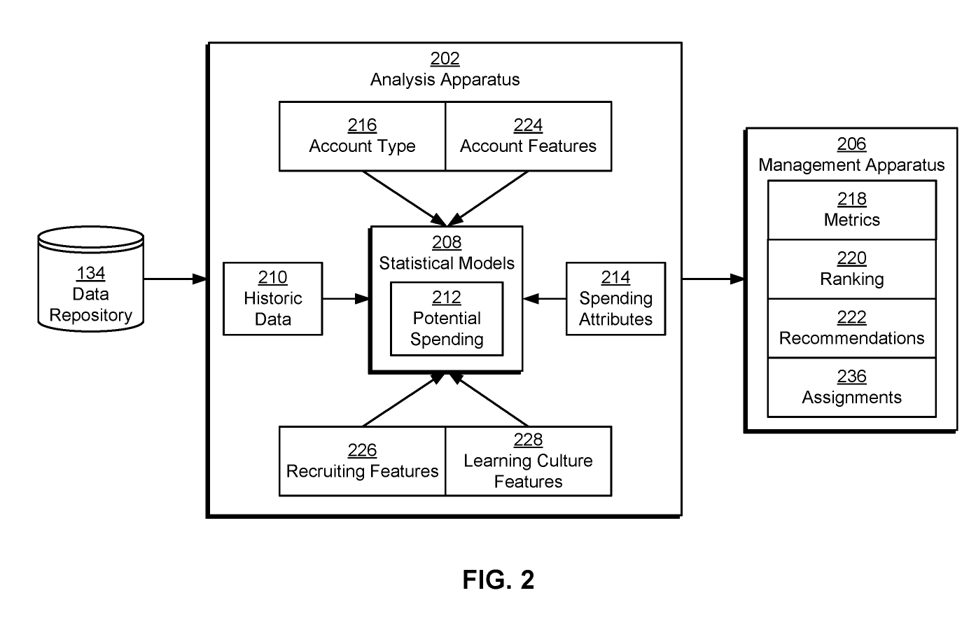

FIG. 2 shows a system for processing data in accordance with the disclosed embodiments. More specifically, FIG. 2 shows a system (e.g., sales-management system 102 of FIG. 1) for evaluating potential spending 212 for a set of customers (e.g., customers 110 of FIG. 1) of an educational technology product. As shown in FIG. 2, the system includes an analysis apparatus 202 and a management apparatus 206. Each of these components is described in further detail below.

As described above, each customer may be a current and/or prospective customer that is identified using data from data repository 134. The customer may be associated with an account type 216 that classifies or categorizes different subsets of customers of the educational technology product. For example, the account type may identify each customer as a company, an educational institution, and/or other type of organization. The account type may optionally identify the size of the company (e.g., individual, small business, medium/enterprise, global/large, etc.) and/or a type of educational institution (e.g., private, public, for-profit, etc.).

Account type 216 may also, or instead, identify whether the customer has an account with an online professional network, such as online professional network 118 of FIG. 1. For example, customers that have accounts with the online professional network may be categorized into enterprise (e.g., corporate) account types for companies or “higher education” account types for educational institutions, while customers that do not have accounts with the online professional network may be commonly categorized into an “off-network” account type.

Analysis apparatus 202 may estimate potential spending 212 for customers of the educational technology product. Potential spending 212 may represent the maximum future spending of each customer with the educational technology product, independent of the customer's likelihood of purchasing the educational technology product. For example, potential spending 212 may represent a dollar amount spent by the customer over a given period (e.g., one year, three years, customer lifetime) and/or the number of licenses the customer will purchase over the period.

If potential spending 212 is estimated by analysis apparatus 202 as the number of licenses the customer will purchase, a dollar amount for the potential spending may be obtained by applying a pricing tier for the customer to the estimated number of licenses. In addition, the pricing tier may be based on the estimated number of licenses and/or the customer's account type 216. For example, a potential spending for a customer that is a company may be calculated by identifying a price a price per license that varies with the number of licenses purchased and/or the size of the company and multiplying the price per license by the estimated number of licenses the customer will purchase. On the other hand, when the customer is an educational institution, the educational technology product may be purchased using a subscription model that specifies, for a given type of educational institution (e.g., public, private for-profit, etc.), a price per student and a price per faculty or staff member. In turn, the analysis apparatus may estimate the number of students and the number of faculty or staff members at the educational institution, and a dollar value for the potential spending may be calculated by multiplying the number of students by the price per student, multiplying the number of faculty or staff members by the price per faculty or staff member, and summing the two products.

Potential spending 212 may optionally account for the customer's likelihood of purchasing the educational technology product. For example, potential spending 212 may be calculated as the maximum future spending of the customer multiplied by the customer's probability of purchasing the educational technology product.

To generate an estimate of potential spending 212 for a customer, analysis apparatus 202 may use account type 216 and/or data from data repository 134 to generate a set of features for the customer, including one or more account features 224, one or more recruiting features 226, and one or more learning culture features 228. For example, analysis apparatus 202 may use one or more queries to obtain the features directly from data repository 134, extract one or more features from the queried data, and/or aggregate the queried data into one or more features.

Account features 224 may include attributes and/or metrics associated with a customer and/or the customer's sales account. Account features 224 for a customer that is a company (i.e., a customer with the enterprise account type) may include demographic attributes such as a location, an industry, a company type (e.g., corporate, staffing, etc.), an age, and/or a size (e.g., small business, medium/enterprise, global/large, number of employees, etc.) of the company.

Account features 224 may also relate to the size and/or composition of the company. When the company has an account with the online professional network, the account features may include a number of employees, a number of employees who are members of the online professional network, a number of employees at a certain level of seniority (e.g., entry level, mid-level, manager level, senior level, etc.) who are members of the online professional network, and/or a number of employees with certain roles (e.g., accounting, design, education, finance, engineering, product management, project management, operations, business development, sales, marketing, executive, etc.) or groups of roles who are members of the online professional network. In turn, the metrics may be used to estimate the size of the company and/or the distribution of roles in the company. The account features may further include a measure of dispersion in the company, such as a number of unique regions (e.g., metropolitan areas, counties, cities, states, countries, etc.) to which the employees and/or members of the online professional network from the company belong.

Account features 224 for a customer that is an educational institution may characterize the size and/or composition of the educational institution. For example, the account features may include historic values for a number of students and a number of faculty or staff members at the educational institution, which may be obtained and/or estimated using online professional network data and/or other publicly available data for the educational institution. The account features may also identify year-over-year differences (e.g., increases or decreases) in the number of students and number of faculty or staff members at the educational institution.

Account features 224 for a customer that does not have an account with the online professional network may be obtained from sales and/or customer relationship management (CRM) data for the customer. For example, the account features may include a number of employees, an industry, and/or a revenue from a CRM account for the customer.

Recruiting features 226 may identify recruiting activity of the customer. For example, recruiting features 230 may include the number of recruiters, talent professionals (e.g., human resources staff), hiring months out of a calendar year, and/or hires in the last year by the customer. The recruiting features may also include a spending of the customer with a recruiting solution or product offered by or through the online professional network.

Learning culture features 228 may characterize the level of learning culture at a customer. For example, the learning culture features may include the number of online professional network connections between employees of the customer and e-learning companies and/or the number of employees in learning and development roles at the customer.

After account features 224, recruiting features 226, and learning culture features 228 are obtained from data repository 134, analysis apparatus 202 may modify some or all of the features. First, the analysis apparatus may apply imputations that add default values, such as zero numeric values or median values, to features with missing values. Second, the analysis apparatus may “bucketize” numeric values for some features (e.g., number of employees) into ranges of values and/or a smaller set of possible values. Third, the analysis apparatus may apply, to one or more subsets of features, a log transformation that reduces skew in numeric values and/or a binary transformation that converts zero and positive numeric values to respective Boolean values of zero and one. Fourth, the analysis apparatus may normalize scores to be within a range (e.g., between 0 and 10), verify that feature ratios are within the range of 0 and 1, and perform other transformations of the features. In general, such preprocessing and/or modification of features by the analysis apparatus may be performed and/or adapted based on configuration files and/or a central feature list.

Next, analysis apparatus 202 may use account features 224, recruiting features 226, learning culture features 228, and/or historic data 210 from data repository 134 as training data for a set of statistical models 208. As described above, the analysis apparatus may obtain a different set of features for customers of different account types (e.g., company, educational institution, non-members of the online professional network). In turn, each set of features may be used to train a separate statistical model for predicting potential spending 212 for customers of the corresponding account type.

Analysis apparatus 202 may also obtain training output for the statistical models as historic spending, historic purchase behavior, and/or other attributes of existing customers that can be used as values of potential spending 212. For example, the analysis apparatus may obtain, as target output for training a statistical model for customers that are companies with accounts on the online professional network, the number of licenses a company will purchase by multiplying the company's current utilization of the educational technology by the number of knowledge workers (e.g., employees in accounting, design, education, finance, engineering, product management, project management, operations, business development, sales, marketing, and/or executive roles) employed by the company. In another example, the analysis apparatus may obtain, as target output for training a statistical model for customers that lack accounts on the online professional network, historic numbers for dollars spent and/or numbers of licenses purchased. In a third example, the analysis apparatus may obtain, as target output for training a statistical model for customers that are educational institutions with accounts on the online professional network, the most recent numbers of students and numbers of faculty or staff members at the educational institutions.

Analysis apparatus 202 may then use the features and historic data 210 to produce different statistical models 208 for evaluating potential spending 212 for the corresponding account types. For example, the analysis apparatus may use the features and values of historic spending to produce separate regression models for different account types representing customers that are companies, educational institutions, and entities that do not have accounts with the online professional network.

After statistical models 208 are created, analysis apparatus 202 and/or another component of the system may update the statistical models based on spending attributes 214 associated with existing customers of the educational technology product. For example, the component may obtain spending attributes such as an overall sales and/or minimum spending (e.g., a minimum number of licenses that can be purchased by a customer) for a given account type, industry, pricing tier, and/or other grouping of existing customers of the educational technology product. In turn, the component may use the spending attributes and/or rankings or proportions associated with the spending attributes to adjust coefficients of regression models for predicting potential spending 212 so that the coefficients better reflect the spending attributes, rankings, and/or proportions.

Analysis apparatus 202 may then use statistical models 208 to predict potential spending 212 for potential and/or existing customers of the educational technology product. For each customer of the educational technology product, the analysis apparatus may identify account type 216 and obtain a set of account features 224, recruiting features 226, and/or learning culture features 228 for inputting into the statistical model for the account type. The statistical model may output a prediction of the number of licenses of the educational technology product that the customer will purchase, and the analysis apparatus may apply a pricing tier to the predicted number of licenses to obtain a dollar value representing the customer's potential spending. For example, the analysis apparatus may match the predicted number of user licenses a company will purchase to a corporate pricing tier that specifies a price per user license for a given range in the number of user licenses (e.g., less than 300 licenses, 300 to 1000 licenses, more than 1000 licenses). The analysis apparatus may then obtain the potential spending by multiplying the predicted number of licenses with the price per user license. In another example, the analysis apparatus may use a statistical model to estimate the number of students and the number of faculty or staff members at an educational institution and obtain a price per student and/or price per faculty or staff member associated with the type of the educational institution (e.g., public, private, for-profit). The analysis apparatus may then calculate the potential spending by multiplying the number of students by the price per student, multiplying the number of faculty members or staff by the price per faculty or staff member, and summing the two products.

After values of potential spending 212 are generated for potential and/or existing customers, management apparatus 206 may output the values for use in managing sales activity with the customers. First, analysis apparatus 202, management apparatus 206, and/or another component of the system may use the potential spending to calculate one or more additional metrics 218 associated with spending by the customers and output the calculated metrics to facilitate understanding of the customers' spending behaviors.

For example, the component may calculate a potential spending penetration as the current bookings for a customer divided by the customer's potential spending 212. The component may also calculate a net ratio growth as the estimated growth rate of the customer's spending in the subsequent year divided by the current-year sales to the customer. The potential spending penetration may then be displayed and/or outputted with the net ratio growth in a chart, table, and/or other visualization to enable identification of customers or groups of customers with higher potential growth and/or future spending.

In another example, the component may segment accounts of the customers by “buckets” of potential spending 212 values and calculate, for each segment, a closing rate representing the proportion of accounts that have closed in the segment. The component may then display or output the closing rate with an average deal size at closing and/or other metrics associated with the segments to facilitate identification of trends and/or patterns among the potential spending, closing rate, average deal size at closing, and/or other metrics 218.

In a third example, the component may calculate one or more scores representing a predicted purchase behavior of the customer with the educational technology product. The scores may include an overall score that represents the customer's likelihood of purchasing the educational technology product and/or a set of sub-scores that characterize different components of the overall score. The scores may then be displayed in a prioritization chart with the potential spending, as described in a co-pending non-provisional application by inventors Zhaoying Han, Patrick King, Yiying Cheng and Julie Wang, entitled “Evaluating and Comparing Predicted Customer Purchase Behavior for Educational Technology Products,” having Ser. No. 15/195,866, and filing date 28 Jun. 2016 (Attorney Docket No. LI-P2017.LNK.US), which is incorporated herein by reference.

Management apparatus 206 may also generate a ranking 220 of the customers by potential spending 212. For example, management apparatus 206 may rank the customers in descending order of potential spending 212 and/or according to other metrics 218 associated with the customers' spending behaviors. Management apparatus 206 may display the ranking in a user interface and/or enable filtering of the ranking by industry, company size, location, and/or other attributes of the customers.

Management apparatus 206 may additionally generate a set of recommendations 222 associated with the customers. For example, management apparatus 206 may recommend targeting of the customers with different acquisition channels and/or sales strategies based on ranking 220 and/or values of potential spending 212. In turn, recommendations 222 may be used to match acquisition channels and/or sales strategies that require significant resources (e.g., interaction with sales or marketing professionals) to customers with higher levels of potential spending 212 and acquisition channels and/or sales strategies that involve fewer resources (e.g., emails, online marketing or sales, etc.) to customers with lower levels of potential spending 212.

Management apparatus 206 may further generate a set of assignments 236 based on ranking 220 and/or recommendations 222. For example, management apparatus 206 may assign customers to sales and/or marketing professionals so that customers with the highest values of potential spending 212 are targeted by the most effective sales and/or marketing professionals. Assignments 236 may also be made so that customers in different market segments (e.g., industries, sizes, locations, account types, etc.) are assigned to sales and/or marketing professionals with expertise in marketing or selling products to those segments. Consequently, the system of FIG. 2 may improve sales and/or marketing of educational technology products by allowing territory planning and/or other sales or marketing activities to be conducted based on values of potential spending 212 of different types of customers.

Those skilled in the art will appreciate that the system of FIG. 2 may be implemented in a variety of ways. First, analysis apparatus 202, management apparatus 206, and/or data repository 134 may be provided by a single physical machine, multiple computer systems, one or more virtual machines, a grid, one or more databases, one or more filesystems, and/or a cloud computing system. Analysis apparatus 202 and management apparatus 206 may additionally be implemented together and/or separately by one or more hardware and/or software components and/or layers.

Second, account type 216, account features 224, recruiting features 226, learning culture features 228, historic data 210, spending attributes 214, and/or other data used to produce potential spending 212 may be obtained from a number of data sources. For example, data repository 134 may include data from a cloud-based data source such as a Hadoop Distributed File System (HDFS) that provides regular (e.g., hourly) updates to data associated with connections, people searches, recruiting activity, and/or profile views. Data repository 134 may also include data from an offline data source such as a Structured Query Language (SQL) database, which refreshes at a lower rate (e.g., daily) and provides data associated with profile content (e.g., profile pictures, summaries, education and work history), profile completeness, and/or estimates of potential spending or other metrics from surveys, polls, or other types of feedback.

Finally, statistical models 208 may be implemented using different techniques and/or used to produce values of potential spending 212 in different ways. For example, statistical models 208 may be implemented using artificial neural networks, Bayesian networks, support vector machines, clustering techniques, regression models, random forests, and/or other types of machine learning techniques. Moreover, different groupings of customers may be used with different statistical models 208. For example, different statistical models 208 may be used to evaluate potential spending 212 for various account types and/or combinations of account features 224, recruiting features 226, and/or learning culture features 228. Multiple statistical models may also be used to generate different estimates of potential spending for a single customer, with a final potential spending for the customer obtained as a maximum, average, threshold, and/or other value associated with the estimates or statistical models. Alternatively, a single statistical model may be used to assess potential spending 212 for all customers of the educational technology product.

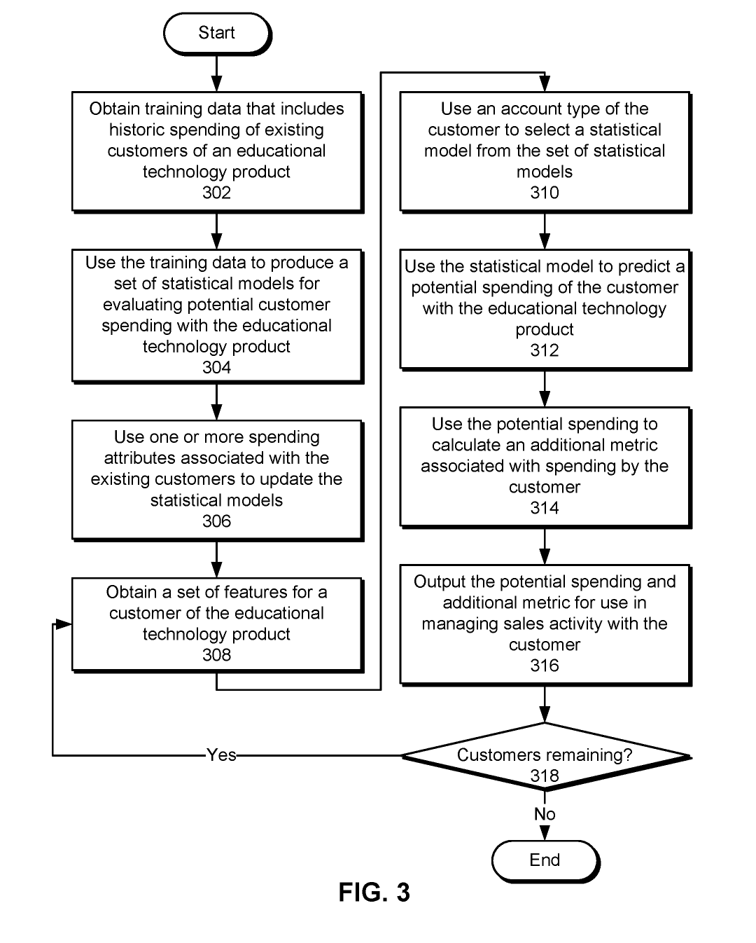

FIG. 3 shows a flowchart illustrating the processing of data in accordance with the disclosed embodiments. More specifically, FIG. 3 shows a flowchart of evaluating potential spending for customers of an educational technology product. In one or more embodiments, one or more of the steps may be omitted, repeated, and/or performed in a different order. Accordingly, the specific arrangement of steps shown in FIG. 3 should not be construed as limiting the scope of the embodiments.

Initially, training data that includes historic spending of existing customers of an educational technology product is obtained (operation 302) and used to produce a set of statistical models for evaluating potential customer spending with the educational technology product (operation 304). For example, the training data may include target output that represents current and/or estimated values of potential spending for the customers. The target output may be generated as a dollar value the customers will spend and/or number of licenses the customers will purchase. The training data may also include features associated with the customers, such as account features, recruiting features, and/or learning culture features. In turn, different sets of features may be used to produce statistical models that predict potential spending for customers of different account types (e.g., companies or educational institutions, organizations of different sizes, customers with or without online professional network accounts, etc.).

Next, one or more spending attributes associated with the existing customers are used to update the statistical models (operation 306). For example, the customers' historic spending with the educational technology product may be aggregated by industry, account type, and/or other attributes and used to generate a rank order of the customers by the aggregated metrics. The rank order and/or aggregated metrics may then be used to adjust regression coefficients and/or other parameters that control the output of the statistical models. In another example, a minimum spending with the educational technology product may be applied as a minimum threshold for output from the statistical models. In other words, the spending attributes may be used to validate and/or improve the output of the statistical models.

After the statistical models are created and validated, a set of features for a customer of the educational technology product is obtained (operation 308), and an account type of the customer is used to select a statistical model from the set of statistical models (operation 310). For example, the features may be obtained from data associated with the customer's account with an online professional network, a CRM account for the customer, and/or publicly available data for the customer. The features may be filtered, transformed, and/or otherwise processed according to the account type and/or the types of input accepted by the statistical model for the account type.

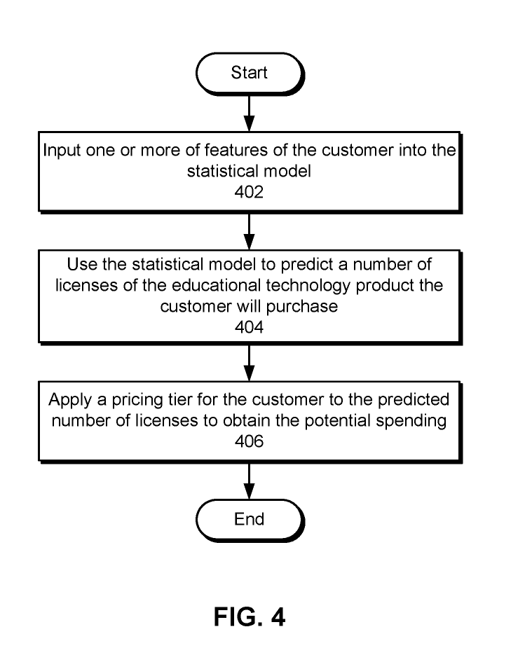

The statistical model is then used to predict the potential spending of the customer with the educational technology product (operation 312), as described in further detail below with respect to FIG. 4. The potential spending is also used to calculate an additional metric associated with spending by the customer (operation 314). For example, the potential spending may be used to produce and/or assess a potential spending penetration, net ratio growth, predicted purchase behavior, and/or closing rate of the customer and/or customers with similar attributes.

Finally, the potential spending and additional metric are outputted for use in managing sales activity with the customer (operation 316). For example, the values of potential spending may be displayed in descending order, along with the names, locations, industries, account types, and/or other attributes of the customers. The potential spending may also be grouped and/or displayed with one or more additional metrics in a table, visualization, and/or other representation. In turn, the displayed values may be used in territory planning, TAM analysis, and/or other sales or marketing activities involving the customers. Operations 308-316 may be repeated for remaining customers (operation 318) of the educational technology product, which may include both existing and prospective customers.

FIG. 4 shows a flowchart illustrating a process of using a statistical model to predict the potential spending of a customer with an educational technology product in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, one or more features of the customer are inputted into the statistical model (operation 402). The features may include account features, recruiting features, and/or learning culture features. Account features for a customer that is a company may include an industry, a number of members of the online professional network, a number of employees, a revenue, a distribution of roles, a number of knowledge workers, and/or a measure of dispersion in the company. Account features for a customer that is an educational institution may include the historic number of students and the historic number of faculty or staff members and/or historic year-over-year changes in the numbers at the educational institution. Recruiting features for the customer may include a number of hires, a number of talent professionals, a number of recruiters, and/or a spending of the customer with another product. Learning culture features for the customer may include a number of employees in learning and development roles and/or a connectedness to educational technology entities in an online professional network.

Next, the statistical model is used to predict the number of licenses of the educational technology product the customer will purchase (operation 404). For example, a statistical model for a customer that is a company may output the number of user licenses the customer will purchase for employees of the company. On the other hand, a statistical model for a customer that is an educational institution may output an estimate of the number of students and the number of faculty or staff members at the educational institution.

Finally, a pricing tier for the customer is applied to the predicted number of licenses to obtain the potential spending (operation 406) of the customer. Continuing with the previous example, the estimated number of user licenses a company will purchase may be matched to a pricing tier that specifies a price per user license for a given range in the number of user licenses purchased. The company's potential spending may then be calculated as the product of the estimated number of user licenses and the price per user license. For a customer that is an educational institution, the type of the educational institution (e.g., private, public, for-profit) may be matched to a pricing tier that specifies a price per student and a price per student or faculty member for the given type of educational institution. The potential spending of the educational institution may then be calculated the product of the number of students and the price per student, which is summed with the product of the number of faculty or staff members and the price per faculty or staff member.

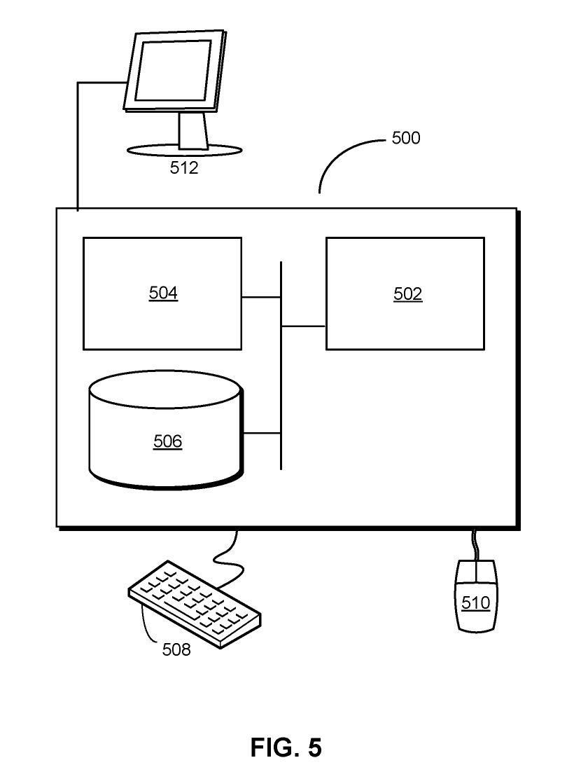

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system may include an analysis apparatus that obtains a set of features for a customer of an educational technology product. Next, the analysis apparatus may use an account type of the customer to select a statistical model from a set of statistical models for evaluating potential customer spending with the educational technology product. The analysis apparatus may then use the statistical model and the features to predict a potential spending of the customer with the educational technology product.

The system may also include a management apparatus that outputs the potential spending for use in managing sales activity with the customer. For example, the management apparatus may generate a ranking, one or more recommendations, and/or one or more assignments of the sales professionals to the second set of customers based on the potential spending values from the statistical models.

In addition, one or more components of computer system 500 may be remotely located and connected to the other components over a network. Portions of the present embodiments (e.g., analysis apparatus, management apparatus, data repository, etc.) may also be located on different nodes of a distributed system that implements the embodiments. For example, the present embodiments may be implemented using a cloud computing system that evaluates potential spending for a set of remote customers.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of features for a customer of an educational technology product;
using an account type of the customer to select a statistical model from a set of statistical models for evaluating potential customer spending with the educational technology product;
using the statistical model and the features to predict, by one or more computer systems, a potential spending of the customer with the educational technology product; and
outputting, by the one or more computer systems, the potential spending for use in managing sales activity with the customer.

2. The method of claim 1, further comprising:
using the potential spending to calculate an additional metric associated with spending by the customer; and
outputting the additional metric with the potential spending.

3. The method of claim 2, wherein the additional metric comprises at least one of:
a potential spending penetration;
a net ratio growth;
a closing rate; and
a predicted purchase behavior.

4. The method of claim 1, further comprising:
obtaining training data comprising historic spending of existing customers of the educational technology product;
using the training data to produce the set of statistical models; and
using one or more spending attributes associated with the existing customers to update the statistical models prior to using the statistical model to predict the potential spending of the customer with the educational technology product.

5. The method of claim 4, wherein the one or more spending attributes comprise at least one of:
an overall sales; and
a minimum spending.

6. The method of claim 1, wherein using the statistical model and the features to predict the potential spending of the customer with the educational technology product comprises:
inputting one or more of the features into the statistical model;
using the statistical model to predict a number of licenses of the educational technology product the customer will purchase; and
applying a pricing tier for the customer to the predicted number of licenses to obtain the potential spending.

7. The method of claim 1, wherein the account type is at least one of:
an enterprise account;
an educational institution account; and
an account with a non-member of an online professional network.

8. The method of claim 1, wherein the set of features comprises at least one of:
an account feature;
a recruiting feature; and
a learning culture feature.

9. The method of claim 8, wherein the account feature for an enterprise account type of the customer is at least one of:
an industry;
a number of members of the online professional network;
a number of employees;
a revenue;
a distribution of roles;
a number of knowledge workers; and
a measure of dispersion in the company.

10. The method of claim 8, wherein the recruiting feature is at least one of:
a number of hires;
a number of talent professionals;
a number of recruiters; and
a spending of the customer with another product.

11. The method of claim 8, wherein the learning culture feature is at least one of:
a number of employees in learning and development; and
a connectedness to educational technology entities in an online professional network.

12. The method of claim 8, wherein the account features for an educational institution account type of the customer comprise:
a number of students; and
a number of faculty or staff members.

13. An apparatus, comprising:
one or more processors; and
memory storing instructions that, when executed by the one or more processors, cause the apparatus to:
obtain a set of features for a customer of an educational technology product;
use an account type of the customer to select a statistical model from a set of statistical models for evaluating potential customer spending with the educational technology product;
use the statistical model and the features to predict a potential spending of the customer with the educational technology product; and
output the potential spending for use in managing sales activity with the customer.

14. The apparatus of claim 13, wherein the memory further stores instructions that, when executed by the one or more processors, cause the apparatus to:
use the potential spending to calculate an additional metric associated with spending by the customer; and
output the additional metric with the potential spending.

15. The apparatus of claim 13, wherein the memory further stores instructions that, when executed by the one or more processors, cause the apparatus to:
obtain training data comprising historic spending of existing customers of the educational technology product;
use the training data to produce the set of statistical models; and
use one or more spending attributes associated with the existing customers to update the statistical models prior to using the statistical model to predict the potential spending of the customer with the educational technology product.

16. The apparatus of claim 13, wherein using the statistical model and the features to predict the potential spending of the customer with the educational technology product comprises:
inputting one or more of the features into the statistical model;
using the statistical model to predict a number of licenses of the educational technology product the customer will purchase; and
applying a pricing tier for the customer to the predicted number of licenses to obtain the potential spending.

17. The apparatus of claim 13, wherein the account type is at least one of:
an enterprise account;
an educational institution account; and
an account with a non-member of an online professional network.

18. The apparatus of claim 13, wherein the set of features comprises at least one of:
an account feature;
a recruiting feature; and
a learning culture feature.

19. A system, comprising:
an analysis module comprising a non-transitory computer-readable medium storing instructions that, when executed by, cause the system to:
obtain a set of features for a customer of an educational technology product;
use an account type of the customer to select a statistical model from a set of statistical models for evaluating potential customer spending with the educational technology product; and
use the statistical model and the features to predict a potential spending of the customer with the educational technology product; and
a management module comprising a non-transitory computer-readable medium storing instructions that, when executed, cause the system to output the potential spending for use in managing sales activity with the customer.

20. The system of claim 19, wherein the non-transitory computer-readable medium of the analysis apparatus further stores instructions that, when executed, cause the system to:
obtain training data comprising historic spending of existing customers of the educational technology product;
use the training data to produce the set of statistical models; and
use one or more spending attributes associated with the existing customers to update the statistical models prior to using the statistical model to predict the potential spending of the customer with the educational technology product.
